(19) United States
(12) Patent Application Publication
(10) Pub. No.: US 2009/0312051 A1
(43) Pub. Date: Dec. 17, 2009

(54) Mobile electronic device

(75) Inventors: Per-Ragnar Hansson, Stockholm (SE); Richard Andreas Axel Hainzl, Sollentuna (SE)

Correspondence Address: Edwards Angell Palmer & Dodge LLP, P.O. Box 55874, Boston, MA, 02205, US

(73) Assignee: Sony Ericsson Mobile Communications AB, Lund (SE)

(21) Appl. No.: 12/157,834

(22) Filed: Jun. 13, 2008

(51) Int. Cl. H04M 1/00

(52) U.S. Cl. 455/556.1

(57) ABSTRACT

In an embodiment, a mobile electronic device is provided which is equipped with one or more pressure-sensitive areas. In an embodiment, pressure or force acting on said pressure-sensitive areas is converted to an electric signal and evaluated by a control unit to control functions of the mobile electronic device.

### FIELD OF THE INVENTION

The present invention relates to mobile electronic devices and methods for controlling mobile electronic devices.

### BACKGROUND OF THE INVENTION

Mobile, i.e. portable electronic devices, are a commodity frequently used in daily life. An example for a commonly used mobile electronic device is a cellular phone. Other types of mobile electronic devices include personal digital assistants (PDAs), smartphones, gaming devices, portable music players, cameras and the like.

With such mobile electronic devices, mechanisms are provided for inputting information into the mobile device in particular to control the mobile device. For example, cellular phones are conventionally equipped with a keypad which is for example used to enter telephone numbers. Additional buttons providing additional control functions like switching on/off may also be provided.

As mobile electronic devices become more elaborate and provide more functions, there is a general need for additional mechanisms and methods for inputting information in a mobile electronic device to control the mobile electronic device.

“Inputting information”, in this respect, is used basically interchangeably with “controlling a function” hereinafter and relates to any kind of information or input which is then further processed or stored in the mobile electronic device or, in other words, causes the mobile electronic device to perform specific functions or tasks. Examples for such information include information to be stored in a database of the mobile electronic device, operation control information, i.e. information which controls the operation of the mobile electronic device, or information to be inputted upon request by the mobile electronic device.

### SUMMARY OF THE INVENTION

In an embodiment, a mobile electronic device is provided, comprising:
at least one portion of piezoelectric material, and
a control unit coupled to said at least one portion of piezoelectric material, said control unit being configured to control at least one function of said mobile electronic device depending on a signal generated by said at least one portion of piezoelectric material.

The mobile electronic device may further comprise a cover at least partially covering an outer surface of said mobile electronic device, and the at least one portion of piezoelectric material may be positioned adjacent to said cover at an inner side of said cover.

In an embodiment, said at least one portion of piezoelectric material may be attached to said inner side of said cover.

Said cover in an embodiment may be arranged such that a location of said at least one portion of piezoelectric material is not visually discernable from an outside of said mobile electronic device.

Said at least one portion of piezoelectric material may for example comprise at least one piezoelectric film.

Said at least one portion of piezoelectric material may comprise polyvinylidene fluoride.

At least one portion of said at least one portion of piezoeletronic material may be positioned for example at a position selected from the group comprising a position on a side surface of the mobile electronic device, a position corresponding to position of fingers when a user grabs the mobile electronic device, a position on a back side of the mobile electronic device, a position at a corner of the mobile electronic device, and a position on a battery cover of the mobile electronic device, a position inside the mobile electronic device, a position on an outer side of the mobile electronic device and a position adjacent to a battery of the mobile electronic device.

Said at least one portion of piezoelectric material may comprise a plurality of portions of piezoelectric material.

In such an embodiment, said control unit may be configured to evaluate signals received from at least some of said plurality of portions of piezoelectric material separately, for example to enable control of different functions through different ones of said portions.

Said at least one function may be user controllable by exerting pressure on at least one portion of said at least one portion of piezoelectric material.

Said at least one function in an embodiment may comprise one or more functions taken from the group comprising a sound control function, a volume control function, a track change function, a messaging function, a locking function, an unlocking function, a damage warning function, a force recording function, an answer call function, a reject call function, a silence call function, an exercise function, a pulse measuring function, a gaming function, a leisure function and a sport function.

The mobile electronic device may further comprise an accelerometer, wherein said control unit is configured to control at least one of the at least one function depending on a signal received from said accelerometer.

Said mobile electronic device may be chosen from the group comprising a cellular phone, a personal digital assistant, a portable gaming device, a smartphone and a portable music player.

Said cover at least at portions covering said at least one portion of piezoelectric material may be made of a flexible material.

According to another embodiment, a mobile electronic device is provided, comprising:
an inner portion,
a flexible cover covering at least part of said inner portion, at least one pressure-sensitive film attached to said cover and arranged between said cover and said inner portion, said at least one pressure-sensitive film being configured to convert a pressure received to an electric signal, and
a control circuit to control said mobile electronic device depending on said signal.

According to a further embodiment, a method for controlling a mobile electronic device is provided, comprising:
receiving pressure on at least one portion of piezoelectric material, converting the pressure to a voltage by said piezoelectric material, and
controlling at least one function of said mobile electronic device depending on said voltage.

Said at least one function may in an embodiment comprise one or more functions taken from the group comprising a sound control function, a volume control function, a track change function, a messaging function, a locking function, an unlocking function, a damage warning function, a force recording function, an answer call function, a reject call function, a silence call function, an exercise function, a pulse measuring function, a gaming function, a leisure function and a sport function.

The above-mentioned features may be freely combined with each other to form additional embodiments unless specifically noted to the contrary.

### BRIEF DESCRIPTION OF THE DRAWINGS

FIG. 1 shows a block diagram of a mobile device according to an embodiment of the present invention,

FIGS. 2A-2C show diagrams for explaining the functioning of PVDF films,

FIGS. 3A-3C show piezoelectric film portions arranged in accordance with some embodiments of the present invention,

FIG. 4 shows a perspective view of a cellular phone according to an embodiment of the present invention,

FIG. 5 shows a perspective view of a cellular phone according to a further embodiment of the present invention, and

FIG. 6 shows a perspective view of a cellular phone according to yet another embodiment of the present invention.

### DETAILED DESCRIPTION OF THE INVENTION

In the following, embodiments of the present invention will be described in detail. It is to be understood that the following description is given only for the purpose of illustration and is not to be taken in a limiting sense. The scope of the invention is not intended to be limited by the embodiments described hereinafter, but is intended to be limited only by the appended claims and equivalents thereof.

It is also to be understood that in the following description of embodiments, any direct connection or coupling between functional blocks, devices, components, circuit elements or other physical or functional units shown in the drawings or described herein, i.e. any connection or coupling without intervening elements, could also be implemented by an indirect connection or coupling, i.e. a connection or coupling with one or more additional intervening elements. Furthermore, it should be appreciated that the partitioning of embodiments into functional blocks or units shown in the drawings is not to be construed as meaning that these units have to be physically separate, but functional blocks or units may be implemented both as separate circuits, chips or circuit elements, but one or more functional blocks or units may also be implemented in common circuit or chips.

It is to be understood that the features of the various embodiments described hereinafter may be combined with each other unless specifically noted otherwise.

Furthermore, it is to be understood that describing an embodiment comprising a plurality of elements or features is not to be construed as indicating that all these elements or features are necessary for practicing the present invention. Instead, in other embodiments, only some of such elements or features and/or alternative elements or features may be present.

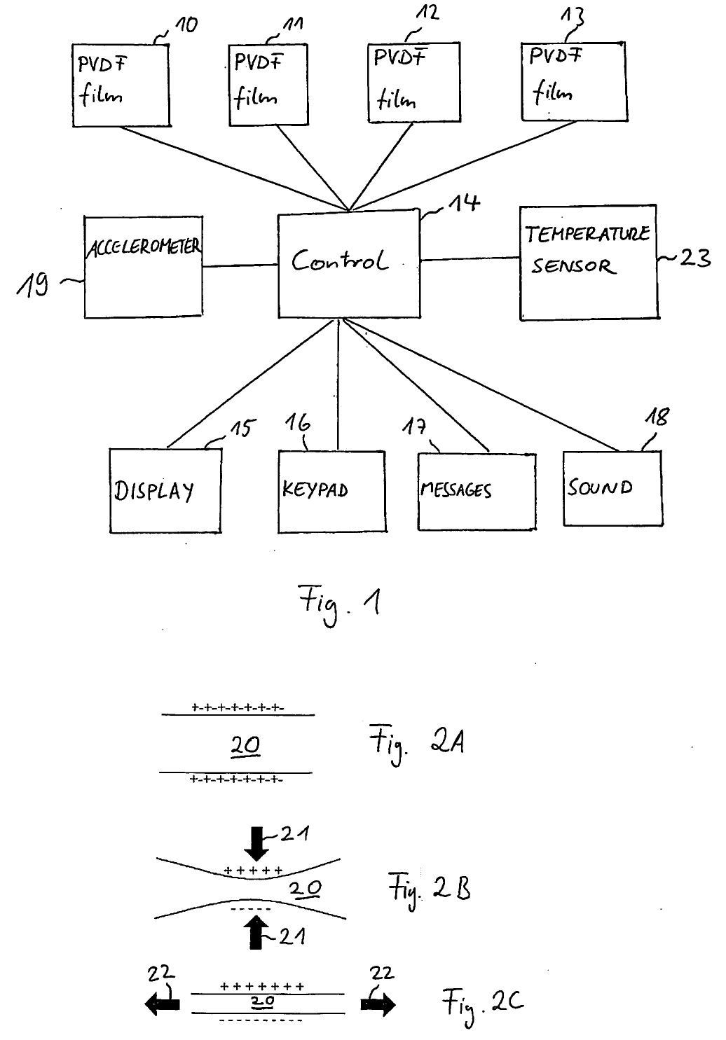

Turning now to FIG. 1, a mobile electronic device according to an embodiment of the present invention is shown. The mobile electronic device in FIG. 1 may be a cellular phone, but may also be a personal digital assistant, gaming device, portable music player or other portable electronic device. It should be noted that in FIG. 1 only some of the components of the electronic device are shown, and the mobile electronic device may comprise further components depending on the type of mobile electronic device. For example, in case the mobile electronic device is a cellular phone, components conventionally found in cellular phones like an antenna, a microphone, a simcard or interface therefore, communication circuitry or other electronic components may be present although not shown in FIG. 1.

The mobile electronic device of the embodiment of FIG. 1 comprises a control unit 14 configured for receiving signals indicating dicating information input into the electronic device and for controlling one or more functions of the electronic device depending on the information input as will be explained in more detail below. Control unit 14 may comprise one or more processing units like central processing units (CPUs), digital signal processors (DSPs), auxiliary processing units or logic circuits. Control unit 14 may also be used to control other functions than the one discussed below in more detail, for example communication functions of a cellular phone or music reproduction functions of a portable music player. On the other hand, in other embodiments for such additional functions, additional control units or processing units may be provided.

Information in this respect is construed to include any kind of information processable by control unit 14, for example information causing control unit 14 to perform specific functions depending on the information input, i.e. information used to control control unit 14 and therefore control the mobile electronic device.

For inputting information, in the embodiment of FIG. 1, a keypad 16, for example a keypad used for entering phone numbers in a cellular phone, is provided. Additionally, an accelerometer 19 is provided which provides information to control unit 14 regarding accelerations of the mobile electronic device, and a temperature sensor 23 is provided which provides information to control unit 14 regarding a temperature of the mobile electronic device.

Furthermore, in the embodiment of FIG. 1, a plurality of polyvinylidene fluoride (PVDF) films or film arrangements, i.e. arrangements comprising one or more PVDF films 10, 11, 12 and 13 are provided. In an embodiment, PVDF films 10-13 are provided at or near a surface of the mobile electronic device.

While four PVDF films 10-13 are shown in FIG. 1, in other embodiments, any other desired number of such films may be provided starting from a single film, and the PVDF films may be arranged at any suitable locations of the mobile electronic device.

PVDF is a highly non-reactive thermoplastic fluoropolymer which exhibits piezo-electricity, i.e. generates a voltage when deformed. This will be briefly explained with reference to FIGS. 2A-2C.

In FIG. 2A, a PVDF film 20 is shown in relaxed or non-deformed state. In this state, positive carriers schematically indicated by “+”-signs and negative carriers indicated by “−”-signs are distributed essentially uniformly such that macroscopically no voltage results. When a compressing force as indicated by arrows 21 in FIG. 2B acts on PVDF film 20, charges are separated leading to a voltage which is detectable and represents information which may be processed by control unit 14. Likewise, as shown in FIG. 2C, a lateral stretching force as indicated by arrows 22 also leads to a separation of charges and a correspondingly applied voltage. Therefore, PVDF films may be used to detect forces acting on them, for example pressure exerted by a finger or other body parts of a user of the mobile electronic device.

It should be noted that depending on the geometry, the resulting voltage may vary with the force or pressure exerted on the PVDF film, such that the voltage may be used as a quantitive measure of the force or pressure exerted.

It should be noted that in the embodiment of FIG. 1, the voltage generated by PVDF films 10-13 may be directly supplied to control unit 14 as an input. In other embodiments, additional elements like resistors, analog to digital converters, capacitors or other circuitry may be provided between PVDS films 10-13 and control unit 14 to convert the voltage to a format or range processable by control unit 14.

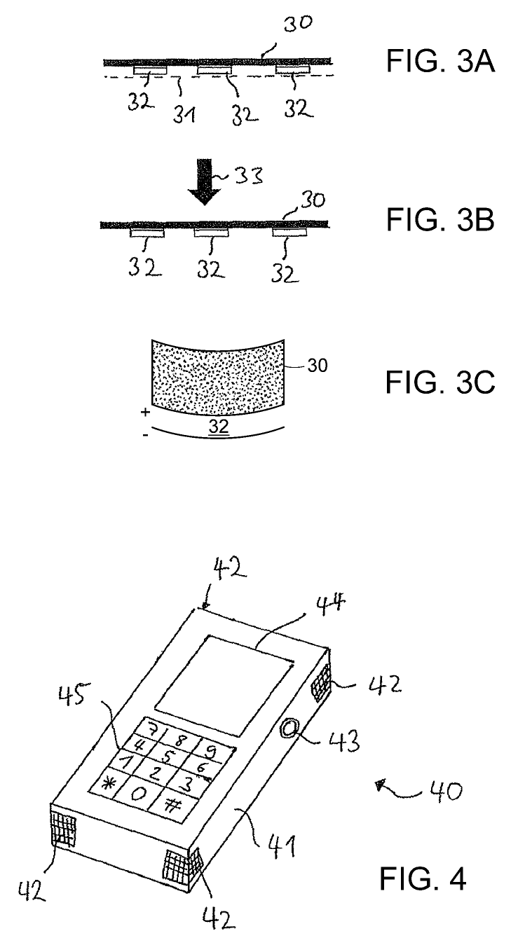

Depending on the information, i.e. the signals received depending on voltages generated by PVDF films 10-13, control unit 14 may control parts of the mobile electronic device. For example, control unit 14 may control a display 15 to display e.g. figures, written messages or pictures, may control a messaging unit 17 to transmit messages like SMS (short message service) messages or MMS (multi media messaging service) messages, or may control a sound unit 18 to emit sounds or music, to change the volume of sounds or music or to change the type or piece of music reproduced. Further examples of the operation of control unit 14 depending on information received from PVDF films 10-13 will be explained in more detail below. Before this discussion, the arrangements of PVDF films according to various embodiments of the present invention will be discussed with reference to FIGS. 3-6. It should be noted that while PVDF films are used in the embodiments described in the following, in other embodiments, other pressure sensitive elements, for example other piezoelectric materials, may be used. Pressure sensitive element in this respect relates to any element capable of converting pressure or force applied to it to an electric signal like a voltage signal.

As will be explained with reference to FIGS. 3A-3C, PVDF films in some embodiments of the present invention are arranged beneath a cover 30 of the mobile electronic device. In the example shown in FIGS. 3A and 3B, a plurality of portions 32 of PVDF film are laminated to cover 30 at an inner side thereof, i.e. such that they are arranged between cover 30 an inner portion 31 of the mobile electronic device. Instead of being laminated to cover 30, portion 32 may be fastened or attached to cover 30 and/or inner portion 31 in some other manner, for example by gluing or by using mechanical means like screws, clips or grooves. While three portions 32 are shown in FIG. 3A, each PVDF film or PVDF film arrangement of the embodiment of FIG. 1 may comprise one or more such portions arranged between cover 30 and an inner portion 31. Cover 30 in the embodiment of FIGS. 3A-3C is made of a flexible material, for example a flexible plastic material. It is to be noted that cover 30 may cover other parts of the mobile electronic device than the parts where portions 32 are arranged, for example the complete mobile electronic devices or parts of the mobile electronic device not occupied by other elements like a keypad, a display or buttons.

When a force acts on cover 30 as indicated by an arrow 33 in FIG. 3B, cover 30 is bent, i.e. deformed, as shown in a magnified manner in FIG. 3C. This leads to a corresponding bending of a portion 32 coupled to cover 30, which in turn as explained above with reference to FIGS. 2A-2C leads to a voltage. Inner portion 31 in such a case may serve as an abutment or support for some parts of portions 32 to increase the deformation caused by exerting pressure on cover 30.

It is to be noted that the cover 30 above portions 32 in an embodiment may be marked, but in another embodiment may be unmarked such that there is no indication of portion 32 being arranged below cover 30 visible from the outside of the mobile electronic device.

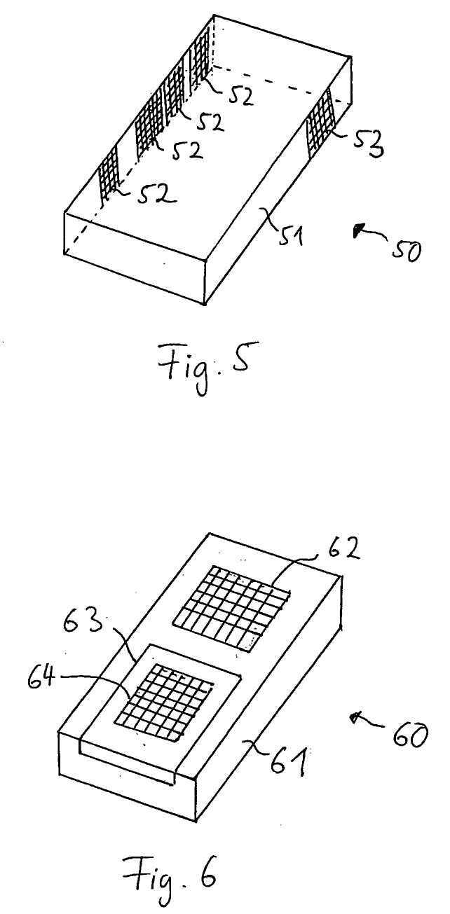

Portions like portions 32 of FIGS. 3A-3C may be arranged at various different locations of a mobile electronic device, or at only one location. Some examples of such locations will be discussed below with reference to FIGS. 4-6.

In FIG. 4, as an example for a mobile device, a cellular phone 40 according to an embodiment of the present invention is shown. Cellular phone 40 comprises a keypad 45 which for example may be used for entering telephone numbers, a display 44 and an additional button 43 which for example may be used for switching on and off the cellular phone. Elements 43, 44 and 45 are conventional cellular phone elements and therefore will not be described in greater detail.

Furthermore, beneath a cover 41 of cell phone 40, PVDF films 42 are arranged. In the embodiment of FIG. 4, PVDF films 42 are arranged at four corner portions of cell phone 40. PVDF films 42 in the embodiment of FIG. 4 are arranged between cover 41 and an inner portion of cellular phone 40, as has been explained with reference to FIGS. 3A-3C.

In an embodiment, pressing cellular phone 40 at one or more of the corner portions 42 causes the respective PVDF film to generate a corresponding voltage, which in turn is received by a control unit like control unit 14 of FIG. 1. The control unit may then control one or more functions in response to the pressure exerted. In an embodiment, the four different PVDF films 42 may be used to control different functions, for example four different functions. In another embodiment, all PVDF films 42 may be used to control the same function. In this case, a user may control this function without actually seeing cellular phone 40, in particular without being aware of the orientation of cellular phone 40.

It should be noted that also groups of PVDF films 42 may control different functions. For example, in an embodiment the PVDF films 42 located adjacent to display 44 may control a first function, and the PVDF films 42 arranged adjacent to keypad 45 may control a second function.

PVDF films 42 each may comprise a single portion of PVDF films or two or more portions of PVDF film, for example three portions as shown in FIG. 3A.

As already discussed with reference to FIGS. 3A-3C, cover 41 which covers PVDF films 42 may bear a marking indicating the areas where PVDF films 42 are arranged, but also may be provided without any marking such that no indication regarding the location of PVDF film 42 is visible from the outside of cellular phone 40.

In FIG. 5, a cellular phone 50 according to another embodiment of the present invention is shown. Similar to cellular phone 40 of the embodiment of FIG. 4, cellular phone 50 may comprise conventional elements like a keypad, a display and one or more buttons, which are not shown in FIG. 5 for clarity's sake. In cellular phone 50 of the embodiment of FIG. 5, on one side face four PVDF films 52 are provided, and on the opposing side face one PVDF film 53 is provided. PVDF films 52, 53 as in the embodiment of FIG. 4 are covered by a cover 51. PVDF films 52, 53 in the embodiment of FIG. 5 are arranged such that a person may grab cellular phone 50 in a manner that his or her thumb rests on the portion of cover 51 covering PVDF film 53, and the remaining four fingers each rest on portions of cover 51 covering one of PVDF films 52. In such an embodiment, with each finger a different PVDF film may be pressed and therefore caused to generate a voltage. Similar to the embodiment of FIG. 4, each PVDF film 52, 53 may be used to control a separate function of cellular phone 50, or some or all of PVDF films 52, 53 may be used to control the same function. It should be noted that which function is controlled by PVDF films 42 of FIG. 4 or PVDF films 52, 53 of FIG. 5 may be user configurable.

It should be noted that instead of the configuration of PVDF films shown in FIG. 5, four PVDF films may be provided on each of two opposing lateral side faces of cellular phone 50 such that operation of PVDF films is possible both with the left hand and with the right hand. On the other hand, separate versions for left hand use and right hand use are also possible. Furthermore, in another embodiment, PVDF film 52 of FIG. 5 may be joined such that a single PVDF film or portions of PVDF film acting jointly, i.e. are provided on one lateral side of a corresponding cellular phone.

In FIG. 6, a cellular phone 60 according to a further embodiment of the present invention is shown. In FIG. 6, cellular phone 60 is shown in a perspective view looking on a backside of the cellular phone, i.e. on a side opposing a side where a display and a keypad similar to the ones shown in FIG. 4 are located. On the backside of cellular phone 60 of the embodiment of FIG. 6, a battery cover 63 covering a battery compartment is provided. Battery cover 63 is provided with a PVDF film 64 such that pressure on the battery compartment may be detected. PVDF film 64 in an embodiment is covered by a covering material of battery cover 63, for example a flexible plastic material. Furthermore, cellular phone 60 of the embodiment of FIG. 6 is provided with a PVDF film 62 covered by a cover 61 of cell phone 60. PVDF film 62 in the embodiment of FIG. 6 is located on the backside of the cellular phone in a portion not occupied by battery cover 63.

It should be noted that the embodiment discussed with respect to FIGS. 4-6 show only some examples illustrating where PVDF films may be provided in order to provide pressure sensitive areas, and other placements of PVDF films are equally possible. For example, one or more PVDF films may also be placed on an outer side of a mobile electronic device, e.g. on an outer side of the cover, or at same other location inside the mobile electronic device, e.g. under a battery covered by battery cover 63 of FIG. 6. In general, any location where it is desirable to detect a pressure or a force may be chosen. Moreover, the embodiments of FIGS. 4-6 may be combined, for example by providing PVDF films both at corner portions like in FIG. 4 and on a backside of a cellular phone as shown in FIG. 6, or by providing PVDF films on side portions as shown in FIG. 5 in addition to PVDF films at corner portions and/or PVDF films on a backside of a cellular phone. Irrespective of the placement, different PVDF films may be used to provide control for different functions, or for providing, control of the same function of the corresponding cellular phone or other mobile electronic device equipped therewith. Furthermore, as already mentioned, instead of PVDF films, any other suitable pressure sensitive material, for example another piezo-electric material, may be used.

Next, examples of functions which may be controlled using PVDF films or other pressure sensitive elements, for example arranged as discussed with reference to FIGS. 4-6, will be discussed in some more detail. It is to be understood that in an embodiment, only one of the functions discussed below may be implemented, but in other embodiments, two or more of such functions may be provided. In an embodiment, the choice which functions of a corresponding mobile electronic device are controlled using PVDF films or similar pressure sensitive areas may be user configurable.

A first group of functions which may be controlled by pressing areas where PVDF films are located is sound control functions. In such an embodiment, as already briefly explained with reference to FIG. 1, a control unit like control unit 14 of FIG. 1 may control a sound unit like sound unit 18 of FIG. 1 depending on signals received from PVDF films like PVDF films 10-13 of FIG. 1. As an example, by “squeezing” a cellular phone which may e.g. have (but is not limited to) PVDF films arranged as discussed with respect to FIG. 5, i.e. by exerting pressure on the PVDF films, a volume of a sound output, for example a music output, may be changed. In an embodiment, for example, successive short squeezes may be used to increase the volume (“pumping up the volume”) and a long squeeze may be used to decrease the volume. In another embodiment, pressing a specific area corresponding to a specific PVDF film may increase the volume, and pressing another area corresponding to another PVDF film may decrease the volume. In another embodiment, pressing an area associated with a specific PVDF film may lead to other sound specific controls, for example a track change of music reproduced, for example by advancing to the next track in a series of music pieces or jumping back to a previous track, a fast forward or fast rewind function for playback, other actions relating to the choice of music or sound reproduced like control of bass, treble or balance. It is to be noted that embodiments may employ one or more of the above-mentioned functions.

Another function which may be controlled by pressing areas corresponding to the locations of PVDF films is a message function, for example by controlling a messaging unit like messaging unit 17 of FIG. 1. In an embodiment, when a user squeezes the mobile electronic device, for example a cellular phone, in a certain way, for example at certain locations and/or with a certain force, a predefined message, for example SMS message or MMS message, is sent to a predetermined recipient. For example, squeezing the phone may be seen as a hug, and a corresponding “hug” message may be sent to the recipient.

A further function which may be implemented in some embodiments of the present invention is a lock/unlock function, where for example a keypad like keypad 16 of FIG. 1 and/or other buttons like button 43 of FIG. 4 may be locked and unlocked, i.e. put to a state where no input is possible or put in a state where input is possible again. In an embodiment, for example pressing a predetermined area associated with a PVDF film may lock or unlock the phone. In another embodiment, for example, a long single squeeze (for example at least one second) which may exert a force for example on one or more of the PVDF films 52, 53 of FIG. 5 may lock the phone, and two short squeezes following each other for example within a second may unlock the phone, or vice versa. It should be noted that in the above example, other time periods than one second may be used. In another embodiment, an acceleration measurement for example by accelerometer 19 of FIG. 1 is additionally taken into account. In such an embodiment, shaking the mobile electronic device while squeezing it may be used to lock or unlock the phone, wherein the shaking motion is detected by the accelerometer and the squeezing is detected by corresponding PVDF films.

A further function which may be implemented in some embodiments of the present invention is a warning function warning a user of forces acting on the mobile electronic device which may potentially damage the phone. For example, when a user accidentally sits on the mobile electronic device, PVDF films like PVDF films 62 and 64 of the embodiment of FIG. 6 are subjected to a force causing a voltage to be generated which then may be taken as an indication of a user sitting on the phone. In this case, a warning message may be displayed on a display like display 15 of FIG. 1 or be output via loudspeaker of the corresponding mobile electronic device. In such an embodiment, the property of PVDF films that a larger force or pressure at least within a certain range leads to a larger voltage being generated may be used to output a warning message only if the acting force and thus the corresponding voltage exceeds a predetermined threshold value.

A further function which is also related to potential damages caused which may be implemented in some embodiments of the present invention is a registration function by which forces acting on the telephone detected by PVDF films are recorded, i.e. stored in a memory, to be used later for damage analysis or other analysis applications. In such an embodiment, all forces acting on the phone may be registered and stored, or only forces exceeding a predetermined threshold as already explained above may be stored. In addition, signals from an accelerometer indicating accelerations exceeding a predetermined threshold may also be stored. In case the mobile electronic device is equipped with a temperature sensor like temperature sensor 23 of FIG. 1, the temperature may additionally be stored. With such stored data, it may for example be found out that a mobile electronic device was used in a non-intended way, for example dropped to the floor or otherwise subjected to excessive forces, which may be useful for example in case of warranty claims.

A further function which may be implemented in some embodiments of the present invention, in particular embodiments where the mobile electronic device is a cellular phone, is to use PVDF films or other pressure-sensitive materials to answer and/or to reject calls. For example, when the cellular phone rings or otherwise indicates an incoming call, two short squeezes of the phone which may for example have an arrangement of PVDF films as discussed with reference to FIG. 5 within for example one second may cause the call to be answered, and a long single squeeze, for example a squeeze with a duration of at least one second, may reject the call, or vice versa. In another embodiment, other squeeze sequences may be used for answering and/or rejecting calls. In still another embodiment, specific areas associated with specific PVDF films may be used for answering or rejecting calls. For example, in the embodiment of FIG. 5, pressing PVDF film 53 may lead to a rejection of the call, and pressing one of PVDF films 52 may lead to answering the call, or vice versa. In still another embodiment, pressing any PVDF film may answer the call, and shaking the telephone which may be detected by an accelerometer like accelerometer 19 of FIG. 1 may reject the call or vice versa. A further function which may be implemented in some embodiments is a silence call function enabling a silencing of an incoming call, i.e. turning off ringing signals emitted by the cellular phone to indicate an incoming call. This function may also be controlled e.g. by a predetermined squeeze sequence. In still another embodiment, a predetermined squeeze sequence or other input via PVDF films may be used to generally set the volume of the mobile electronic device to zero, i.e. to turn off all sound reproduction by the mobile electronic device.

A further function which may be provided in some embodiments of the present invention is a sports/workout function where the mobile electronic device is used as a sport tool. For example, in an embodiment, an exercise comprises repeatedly squeezing the phone for strengthening muscles in hand or forearm. A control unit of the mobile electronic device may for example count the number of repetitions of squeezing the phone detected by PVDF films and display it on a display. Other more complex exercises may comprise pressing various PVDF films in an order indicated on a display of the mobile electronic device like display 15 of FIG. 1 or display 44 of FIG. 4. In another embodiment, an exercise program additionally uses an accelerometer to involve exercises where the phone is not only squeezed or pressed, but for example also swung.

The above-mentioned sport or exercising in an embodiment may be combined with a pulse measuring function. In other embodiments, a pulse measuring function may be implemented independently of such sport or exercising functions.

With such a pulse measuring function, when a user grabs the mobile device such that one or more fingertips rest on areas associated with PVDF film, the pulse in the fingertip(s) causes a change of pressure acting on the respective PVDF film(s), which in turn may be used to measure the pulse frequency. The pulse frequency in an embodiment is then displayed on a display of the mobile electronic device and/or output as sound messages. For such a pulse measuring application, a configuration of PVDF films as discussed with respect to FIG. 5 may be used in an embodiment, although the present invention is not limited in this respect. Furthermore, in other embodiments other parts of the body than fingertips may be used for pulse detection.

A still further function in connection with the use of PVDF films which may be implemented in some embodiments of the present invention is a gaming or leisure function. For example, the areas where PVDF films are located may serve as game controller for any game like an arcade game running on the mobile electronic device. For example, a sport game may be provided where it is an objective to exert pressure on one or more PVDF films in a given order and/or with a given rhythm. In another leisure application, the mobile electronic device may be used to reproduce music, and for a game a user has to “track the beat”, i.e. exert pressure on PVDF films provided in the mobile electronic device corresponding to the rhythm of the music. Such gaming applications or leisure applications may in an embodiment additionally use signals obtained by an accelerometer as described above, for example to allow for additional game control or, in case of a music-based activity, to check whether movements of a person grabbing the mobile electronic device are in line with the rhythm of the music.

Embodiments of the present application are not limited to the above-mentioned functions, and general PVDF films or pressure-sensitive zones may be used to replace mechanical or touch-based buttons for controlling any function of the mobile electronic device, for example an internet browser, a camera incorporated in the device, music reproduction or telecommunication. Moreover, while above squeezing the entire mobile device or pressing areas associated with specific PVDF film were discussed, PVDF films may also be arranged such that different kinds of motions, for example a pushing motion, a pulling motion or a twisting motion acting on the mobile electronic device and/or different magnitudes of forces and/or pressures may be discerned and used to control different functions and/or to provide different input possibilities.

As already mentioned, the above-mentioned functions and control possibilities may be implemented separately, but also so two or more of these functions may be combined. Further modifications and variants of the present invention will be apparent to a person skilled in the art when studying the present specification, and therefore the present invention is not to be construed to be limited to the embodiments described above, but is intended to be limited only by the appended claims and equivalents thereof.

What is claimed is:

1. A mobile electronic device comprising:
at least one portion of piezoelectric material, and
a control unit coupled to said at least one portion of piezoelectric material, said control unit being configured to control at least one function of said mobile electronic device depending on a signal generated by said at least one portion of piezoelectric material.

2. The mobile electronic device of claim 1, further comprising:
a cover at least partially covering an outer surface of said mobile electronic device,
wherein said at least one portion of piezoelectric material is positioned adjacent to said cover at an inner side of said cover.

3. The mobile electronic device according to claim 2,
wherein said at least one portion of piezoelectric material is attached to said inner side of said cover.

4. The mobile device of claim 2,
wherein said cover is arranged such that a location of said at least one portion of piezoelectric material is not visually discernable from an outside of said mobile electronic device.

5. The mobile electronic device of claim 1,
wherein said at least one portion of piezoelectric material comprises at least one piezoelectric film.

6. The mobile device of claim 1,
wherein said at least one portion of piezoelectric material comprises polyvinylidene fluoride.

7. The mobile electronic device of claim 1,
wherein at least one portion of said at least one portion of piezoeletronic material is positioned at a position selected from the group comprising a position on a side surface of the mobile electronic device, a position corresponding to positions of fingers when a user grabs the mobile electronic device, a position on a back side of the mobile electronic device, a position at a corner of the mobile electronic device, a position on a battery cover of the mobile electronic device, a position inside the mobile electronic device, a position on an outer side of the mobile electronic device and a position adjacent to a battery of the mobile electronic device.

8. The mobile electronic device of claim 1,
wherein said at least one portion of piezoelectric material comprises a plurality of portions of piezoelectric material, and wherein said control unit is configured to evaluate signals received from at least some of said plurality of portions of piezo-electric material separately.

9. The mobile electronic device according to claim 1,
wherein said at least one function comprises one or more functions taken from the group comprising a sound control function, a volume control function, a track change function, a messaging function, a locking function, an unlocking function, a damage warning function, a force recording function, an answer call function, a reject call function, a silence call function, an exercise function, a pulse measuring function, a gaming function, a leisure function and a sport function.

10. The mobile electronic device of claim 1, further comprising:
an accelerometer,
wherein said control unit is configured to control at least one of the at least one function depending on a signal received from said accelerometer.

11. The mobile electronic device of claim 1,
wherein said mobile electronic device is chosen from the group comprising a cellular phone, a personal digital assistant, a portable gaming device, a smartphone and a portable music player.

12. The mobile electronic device of claim 1,
wherein said cover at least at portions covering said at least one portion of piezoelectric material is made of a flexible material.

13. The mobile electronic device of claim 1,
wherein said at least one function is controllable by a user by exerting pressure on at least one portion of said at least one portion of piezoelectric material.

14. A mobile electronic device, comprising:
an inner portion,
a flexible cover covering at least part of said inner portion,
at least one pressure-sensitive film attached to said cover and arranged between said cover and said inner portion, said at least one pressure-sensitive film being configured to convert a pressure received to an electric signal, and
a control circuit to control said mobile electronic device depending on said signal.

15. A method for controlling a mobile electronic device, comprising:
receiving pressure on at least one portion of piezoelectric material,
converting the pressure to a voltage by said piezoelectric material, and
controlling at least one function of said mobile electronic device depending on said voltage.

16. The method of claim 15,
wherein said at least one function comprises one or more functions taken from the group comprising a sound control function, a volume control function, a track change function, a messaging function, a locking function, an unlocking function, a damage warning function, a force recording function, an answer-call function, a reject-call function, an exercise function, a pulse measuring function, a gaming function, a leisure function and a sport function.
